(19) United States
(12) Patent Application Publication
(10) Pub. No.: US 2014/0223340 A1
(43) Pub. Date: Aug. 7, 2014

(54) METHOD AND ELECTRONIC DEVICE FOR PROVIDING DYNAMIC MAP-TYPE GRAPHIC INTERFACE

(71) Applicant: HON HAI PRECISION INDUSTRY CO., LTD., New Taipei (TW)

(72) Inventor: YOUNG-WAY LIU, New Taipei (TW)

(73) Assignee: HON HAI PRECISION INDUSTRY CO., LTD., New Taipei (TW)

(21) Appl. No.: 14/164,142

(22) Filed: Jan. 25, 2014

(30) Foreign Application Priority Data
Feb. 5, 2013 (CN) 2013100442197

(51) Int. Cl. G06F 3/0484

(52) U.S. Cl. CPC G06F 3/0484
USPC 715/762

(57) ABSTRACT

A dynamic map-type graphic interface includes a number of user interface (UI) components. Each UI component is associated with one corresponding application program of the electronic device. The dynamic map-type graphic interface is a single-layer graphic interface made up of the UI components spliced together and centered around a center of the dynamic map-type graphic interface. A partial region of the dynamic map-type graphic interface corresponding to a size of a display unit of the electronic device is displayed on the display unit and centered around a display center of the dynamic map-type graphic interface.

### BACKGROUND

1. Field

The present disclosure relates to graphic user interface technologies, and particularly to a dynamic map-type graphic interface, an electronic device providing the dynamic map-type graphic interface, and a method for the electronic device to provide the dynamic map-type graphic interface.

2. Background

User interfaces (UIs) are physical or virtual mediums through which a user interacts with an electronic device. Most UIs of electronic devices use graphic user interface (GUI) components supported in an operating system (OS). The GUIs of electronic devices may have many application icons, such that it is necessary to arrange the application icons in different layers or pages of the GUI. However, as the number of the application icons increases, it may become difficult to keep track of which page a particular application icon is in. Furthermore, one UI is not compatible with different electronic devices having different display sizes.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an embodiment of an electronic device.

FIG. 2 is a block diagram of the electronic device of FIG. 1.

FIG. 3 is a schematic view of an embodiment of a dynamic map-type graphic interface.

FIG. 4 is a schematic view of another embodiment of a dynamic map-type graphic interface.

FIG. 5 is a flowchart of an embodiment of a method for providing the dynamic map-type graphic interface.

FIG. 6 is a schematic view of an embodiment of a moving process of the dynamic map-type graphic user interface.

FIG. 7 is a flowchart of an embodiment of a control method for controlling a user interface of the electronic device employing the dynamic map-type graphic interface.

FIG. 8 shows sub-steps of the flowchart of FIG. 7.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

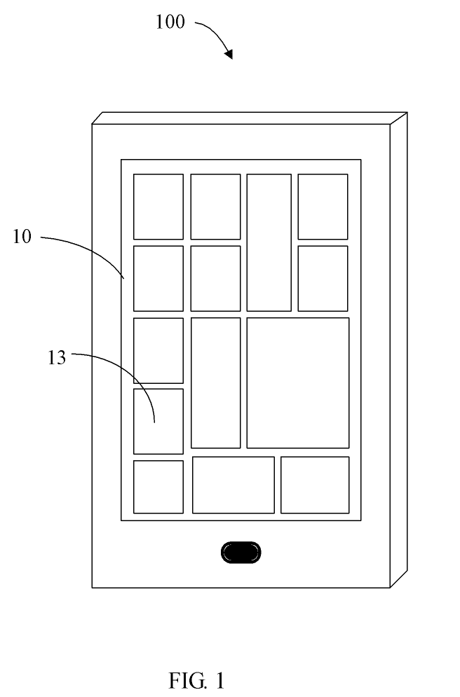

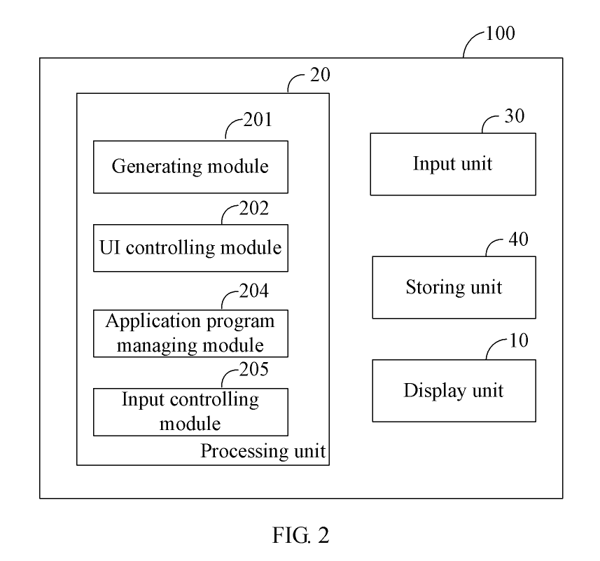

Referring to FIGS. 1 and 2, an electronic device 100 includes a display unit 10, a processing unit 20, an input unit 30, and a storing unit 40. The display unit 10 of the electronic device 100 can be any size, and the electronic device 100 can be, without limitation, a television, an electronic whiteboard, a desktop personal computer, a notebook, a tablet personal computer, or a smart phone. The electronic device 100 provides a user interface (UI, not labeled) displayed on the display unit 10. A number of UI components 13 are arranged in the UI.

In this embodiment, the storing unit 40 is a non-transitory computer-readable medium configured to store a number of documents and multimedia files, such as video files, music files, and images. The storing unit 40 further stores a number of application programs and UI components 13 associated with the application programs. The UI components 13 include application icons and different kinds of widgets. Each of the application icons and widgets is associated with a corresponding application program. In one embodiment, the widget is a window for dynamically displaying images or information, such as weather information or time, or a thumbnail of a document, video, or image stored in the storing unit 40. In other embodiments, the widget is an interactive widget configured to provide feedback and display a processing result in response to a user's input. For example, the interactive widget is a currency converter, which includes an input box for receiving input of a currency and a currency amount, and displays a converted result.

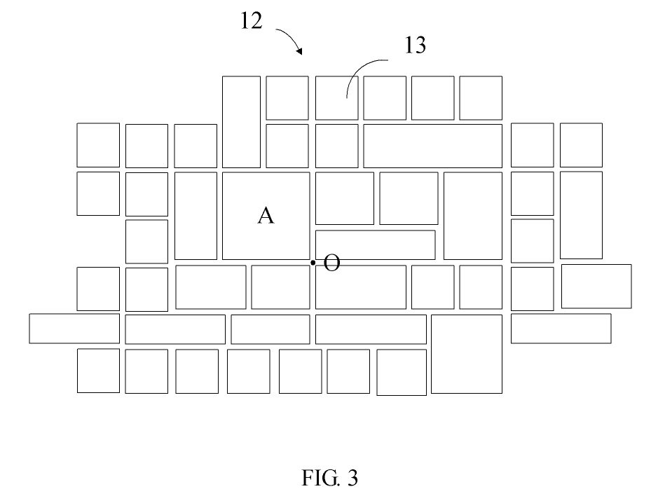

The display unit 10 is configured to display videos, documents, Internet web pages, a running interface of a program, a UI, and the like. The processing unit 20 is configured to run the application programs and control the display unit 10. The storing unit is further configured to store software instruments. The software instruments are run by the processing unit 20 for enabling the electronic device 100 to implement a dynamic map-type graphic interface 12 (shown in FIG. 3).

The input unit 30 can be selected from a contactless input device or a contact-type input device. The contactless input device can be a wireless control technology, such as gesture control technology or voice control technology. The contact-type input device can be a touch input device, such as a capacitive touch screen, a resistive touch screen, an Infrared touch screen, or other optical touch input device, or other type of input device, such as a keyboard or a button.

The processing unit 20 includes a generating module 201, a UI controlling module 202, an application program managing module 204, and an input controlling module 205.

FIG. 3 shows an embodiment of a dynamic map-type graphic interface 12. The dynamic map-type graphic interface 12 is made up of the UI components 13 on a single page. The UI components 13 are dynamically arranged according to a predetermined rule. Each of the UI components 13 is associated with one application program.

In this embodiment, the UI components 13 are arranged around a predetermined center O and spliced together to form the dynamic map-type graphic interface 12. A size of the dynamic map-type graphic interface 12 increases as the number of the UI components 13 increases. Each of the UI components 13 is a block of the map. A size, shape, and content of the block are determined by a character of the associated application program, or set by a user.

The size of the UI component 13 is measured by a predetermined unit of measure.

In one embodiment, 1 unit is defined as 0.2 inch. For example, if the size of a UI component 13 is 1×4, the horizontal size of the UI component 13 is 0.2 inch, and the vertical size of the UI component 13 is 0.8 inch.

In another embodiment, the size of the UI component 13 is defined by pixel values. For example, if the size of the UI component 13 is 50×50, the horizontal size and the vertical size of the UI component 13 are both 50 pixels.

For example, a block A of the dynamic map-type graphic interface 12 is an application program for the weather and has a 3×3 size. Therefore, the horizontal size and the vertical size of the block A are both 0.6 inch. The content of the block A can include a static or dynamic image showing weather information of a city.

The UI components 13 are arranged around the predetermined center O according to the predetermined rule and spliced together. The UI components 13 are spliced together means that the UI components 13 are arranged around the center one by one according to the predetermined rule. The UI components 13 can be arranged closer to the center O according to a frequency of use, a time of installation, or other condition defined by a user. In other embodiments, arrangement of the UI components 13 on the dynamic map-type graphic interface 12 is random or determined by a user.

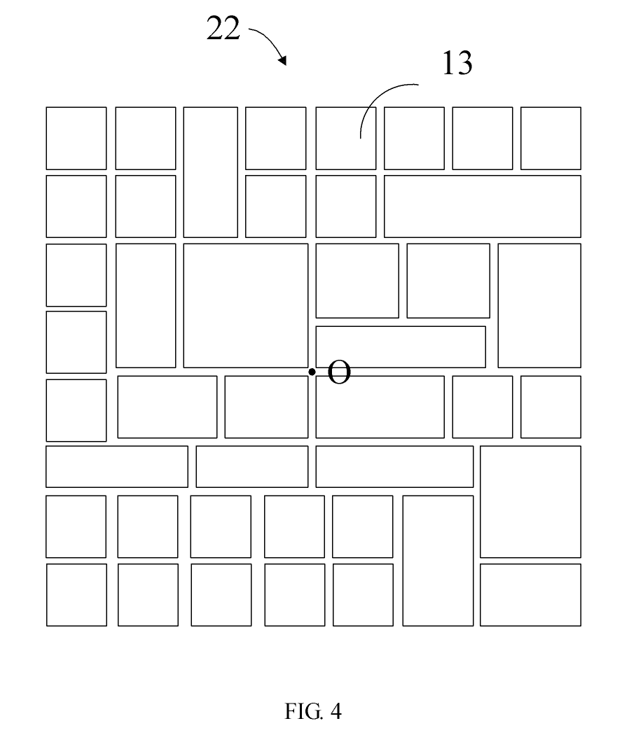

FIG. 4 shows another embodiment of a dynamic map-type graphic interface 22. A difference between the dynamic map-type graphic interface 22 and the dynamic map-type graphic interface 12 of the first embodiment is that the dynamic map-type graphic interface 22 is rectangular and has a fixed aspect ratio. As the number of the UI components 13 increases, the size of the rectangle increases to maintain the fixed aspect ratio of the dynamic map-type graphic interface 22.

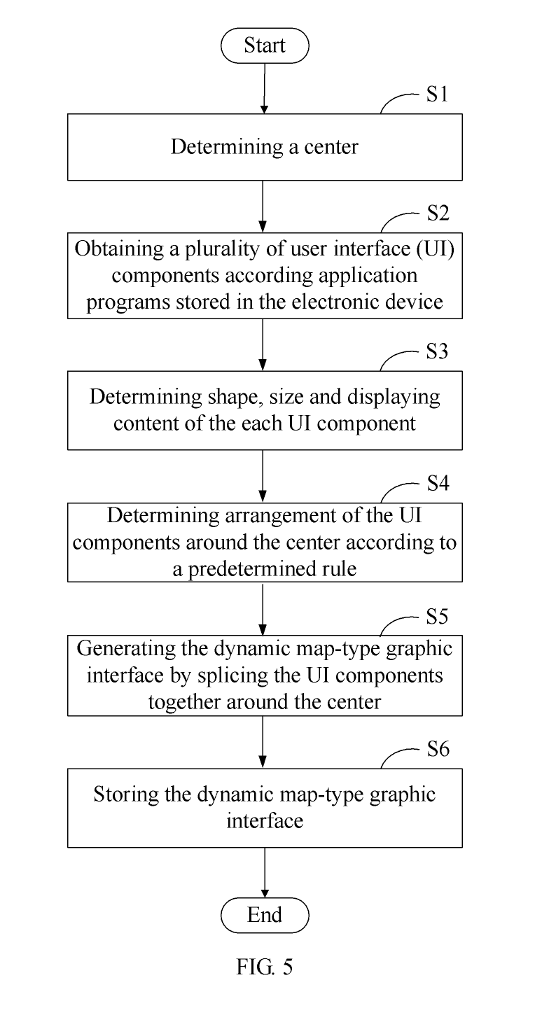

FIG. 5 shows a flowchart of a method for providing the dynamic map-type graphic interface 12. The method includes the following steps, each of which is tied to various components contained in the electronic device 100 as shown in FIG. 2.

In step S1, the generating module 201 determines a center O.

In step S2, the application program managing module 204 obtains the number of the UI components 13 according to the application programs stored in the electronic device 100.

In step S3, the application program managing module 204 determines the shape, size, and content of each UI component 13 according to the character of the application program associated with each UI component 13, or according to user input.

In step S4, the generating module 201 determines the arrangement of the UI components 13 around the center O according to the predetermined rule. In other embodiments, the arrangement of the UI components 13 is random or determined by a user.

In step S5, the generating module 201 generates the dynamic map-type graphic interface 22 by splicing the UI components 13 together around the center O.

In step S6, the dynamic map-type graphic interface 22 is stored in the storing unit 40 of the electronic device 100.

In other embodiments, the generating module 201 splices the UI components 13 together around the center O to form a dynamic picture.

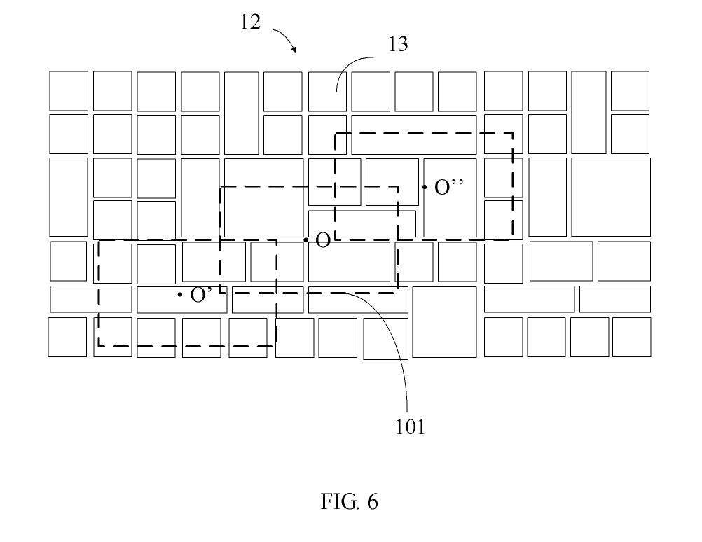

Referring to FIG. 6, when the size of the dynamic map-type graphic interface 12 is larger than a display size of the display unit 10, the UI controlling module 202 of the processing unit 20 determines a point of the dynamic map-type graphic interface 12 as a display center, then controls the display unit 10 to display a partial region 101 of the dynamic map-type graphic interface 12 centered around the display center. In this embodiment, a size of the partial region 101 is the size of the display unit 10.

In this embodiment, the center O is determined as the display center. In other embodiments, any point of the map-type graphic interface 12, such as a point O′ or a point O″, can be defined as the current display center. The current display center can be the most recent display center or be set by a user.

The input unit 30 is configured to receive a user's input and generate an input command in response to the input. The input controlling module 205 of the processing unit 20 generates corresponding control signals according to the different input commands. The UI controlling module 202 controls the display center of the dynamic map-type graphic interface 12 to move according to the control signal when the input command is the movement command.

For example, as shown in FIG. 6, The UI controlling module 202 controls the display center of the dynamic map-type graphic interface 12 to move from the center O to the point O′ or O″, then the partial region 101 is moved accordingly to center around the point O′ or the point O″.

For example, if the input unit 30 is a touch panel, when the user swipes the touch panel, the input unit 30 generates the corresponding input command. The input controlling module 205 determines a distance and a direction of the swipe, and generates the control signal according to the movement command. The control signal includes information of the distance and the direction of the swipe. The UI controlling module 202 determines a moving distance and a moving direction according to the control signal, and controls the display center of the dynamic map-type graphic interface 12 to move according to the determined moving direction and the determined moving distance.

In one embodiment, the moving direction is the same as the swiping direction, and the moving distance is proportional to the swiping distance. For example, when the swiping distance is 0.5 cm, the determined moving distance is 1 unit.

In another embodiment, the moving direction is opposite to the swiping direction.

When the display center is adjacent to a boundary of the dynamic map-type graphic interface 12, the UI controlling module 202 redefines the display center, such that the partial region 101 is within the dynamic map-type graphic interface 12.

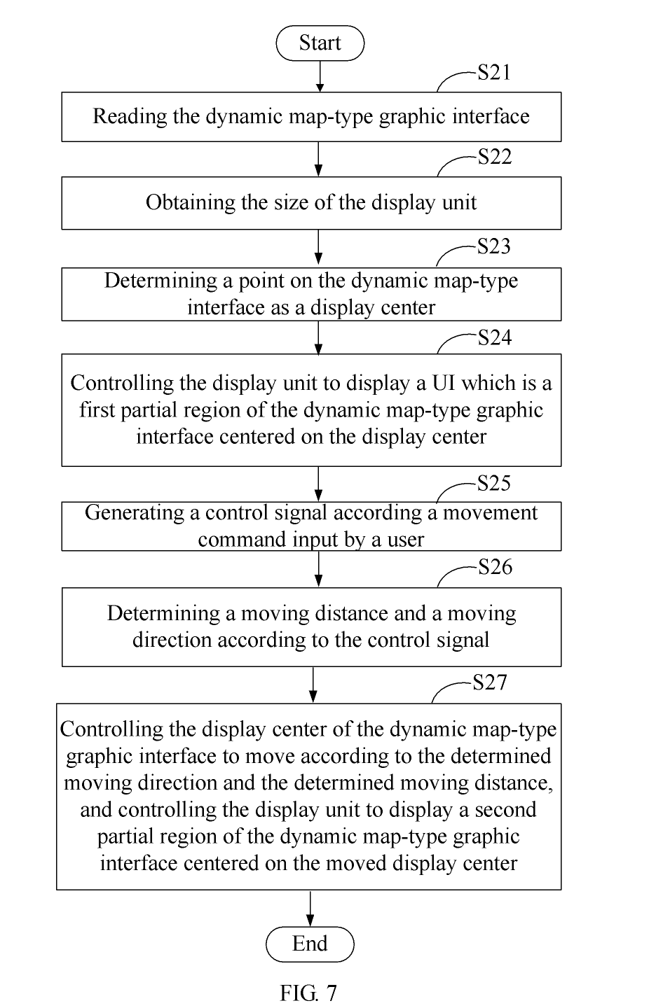

Referring to FIG. 7, a flowchart of a method for controlling the partial region 101 displayed on the electronic device 100 is illustrated. The method includes the following steps, each of which is tied to various components contained in the electronic device 100 as shown in FIG. 2.

In step S21, the UI controlling module 202 reads the dynamic map-type graphic interface 12 from the storing unit 40.

In step S22, the UI controlling module 202 obtains the size of the display unit 10. In one embodiment, the UI controlling module 202 further determines whether the size of the display unit 10 is larger than the size of the dynamic map-type graphic interface 12. If the size of the display unit 10 is larger than the size of the dynamic map-type graphic interface 12, step S23 is implemented. Otherwise, the UI controlling module 202 controls the display unit 10 to display the content of dynamic map-type graphic interface 12.

In step S23, the UI controlling module 202 determines a point on the dynamic map-type interface as a display center. In this embodiment, the UI controlling module 202 determines the center O of the dynamic map-type graphic interface 12 as the display center. In other embodiments, any point selected by a user or the most recent display center can be defined as the current display center.

In step S24, the UI controlling module 202 controls the display unit 10 to display the partial region 101 of the dynamic map-type graphic interface 12 centered around the display center.

In step S25, the input controlling module 205 generates a control signal according to a movement command input by a user.

In step S26, the UI controlling module 202 determines a moving distance and a moving direction according to the control signal.

In step S27, the UI controlling module 202 controls the display center of the dynamic map-type graphic interface 12 to move according to the determined moving direction and the determined moving distance, and controls the display unit 10 to display the partial region 101 centered around the moved display center.

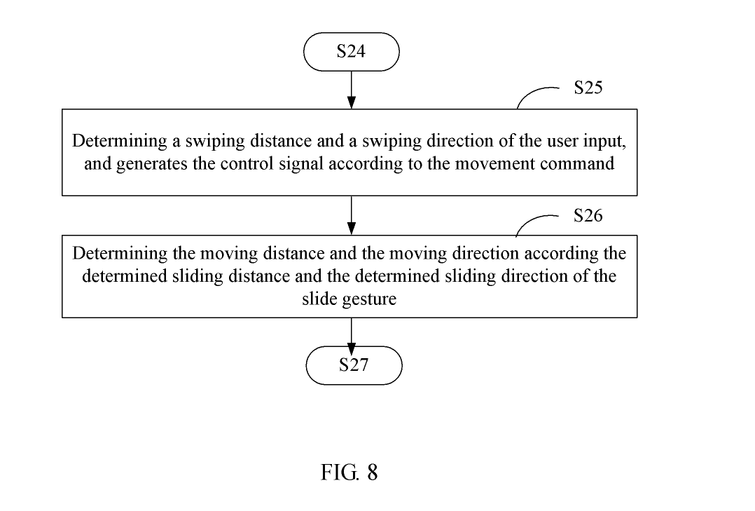

Referring to FIG. 8, when the input unit 30 is a touch panel, in step S25, the input controlling module 205 determines a swiping distance and a swiping direction of the user input, and generates the control signal according to the movement command.

The control signal includes information of the swiping distance and the swiping direction of the user input.

Step S26 further includes the UI controlling module 202 determining the moving distance and the moving direction according to the determined swiping distance and the determined swiping direction of the user input.

The dynamic map-type graphic interface 12 is a single-layer graphic interface made up of the UI components 13 spliced together. The UI components 13 are dynamically arranged around the center O. Furthermore, the dynamic map-type graphic interface 12 is compatible with different electronic devices having different display sizes.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A method for providing a dynamic map-type graphic interface of an electronic device, comprising:
S1, determining a center of the dynamic map-type graphic interface;
S2, obtaining a plurality of user interface (UI) components according application programs stored in the electronic device;
S3, determining shape, size and content of each UI component;
S4, determining arrangement of the UI components around the center according a predetermined rule;
S5, generating the dynamic map-type graphic interface by splicing the UI components together around the center;
S6, storing the dynamic map-type graphic interface.

2. The method of claim 1, wherein the shape, size and displaying content of the each UI component are determined according to a character of the application program associated with each UI component, or according to user's input.

3. The method of claim 1, wherein in step S4, the UI components are arranged closer to the center O according to a frequency of use, a time of installation.

4. The method of claim 1, wherein in step S4, the arrangement of the UI components on the dynamic map-type graphic interface is random or determined by a user.

5. The method of claim 4, wherein the UI components comprises application icon and different kinds of widgets, each of the application icon and widgets is associated with a corresponding application program.

6. An electronic device for providing a dynamic map-type graphic interface, comprising:
a display unit;
a storing unit configured to record a plurality of application programs and user interface (UI) components associated with the application programs; and
a processing unit comprising
an application program managing module configured to obtain the plurality of the UI components and determine shape, size and displaying content of the each UI component;
an generating module configured to determine a center, determine arrangement of the UI components around the center according the predetermined rule, and generate the dynamic map-type graphic interface by splicing the UI components together around the center;
an UI controlling module configured to control the display unit to display a partial region of the dynamic map-type graphic interface for user interacting, wherein a size of the partial region is the size of the display unit.

7. The electronic device of claim 6, wherein the shape, size and displaying content of the each UI component are determined according to a character of the application program associated with each UI component, or according to user's input.

8. The electronic device of claim 6, wherein the UI components are arranged closer to the center O according to a frequency of use, a time of installation.

9. The electronic device of claim 6, wherein the arrangement of the UI components on the dynamic map-type graphic interface is random or determined by a user.

10. The electronic device of claim 9, wherein the UI components comprises application icon and different kinds of widgets, each of the application icon and widgets is associated with a corresponding application program.

11. An program product for enabling electronic device to implement a dynamic map-type graphic interface, the program product comprising:
software instruments for enabling the electronic device to implement a dynamic map-type graphic interface; and
a storing unit for recording the software instruments;
the dynamic map-type graphic interface comprising:
a center and a plurality of user interface (UI) components associated with a corresponding application program of the electronic device;
wherein the dynamic map-type graphic interface is spliced by the UI components together around the center, a partial region of the dynamic map-type graphic interface is displayed on a display unit for user interacting, a size of the partial region is the size of the display unit.

12. The program product of claim 11, wherein a shape, a size and a displaying content of the each UI component are determined according to a character of the application program associated with each UI component, or according to user's input.

13. The program product of claim 11, wherein the UI components are arranged closer to the center O according to a frequency of use, a time of installation.

14. The program product of claim 11, wherein the arrangement of the UI components on the dynamic map-type graphic interface is random or determined by a user.

15. The program product of claim 14, wherein the UI components comprises application icon and different kinds of widgets, each of the application icon and widgets is associated with a corresponding application program.
